(19) United States
(12) Patent Application Publication
(10) Pub. No.: US 2020/0047700 A1
(43) Pub. Date: Feb. 13, 2020

(54) AIRBAG MODULE AND VEHICLE BODY

(71) Applicant: Dalphi Metal Espana S. A., Vigo (ES)

(72) Inventors: Pedro Jose Santin Navarro, Vigo (ES); Pilar Abelenda Abelenda, Vigo (ES); Patricia Bouzas Tobio, Vigo (ES)

(73) Assignee: Dalphi Metal España S. A., Vigo (ES)

(21) Appl. No.: 16/345,863

(22) PCT Filed: Oct. 26, 2017
(86) PCT No.: PCT/EP2017/077402

§ 371 Date: Apr. 29, 2019

(30) Foreign Application Priority Data
Nov. 3, 2016 (DE) 20 2016 106 156.3

(51) Int. Cl. B60R 21/217

(52) U.S. Cl. CPC B60R 21/217; B60R 21/237

(57) ABSTRACT

An airbag module for an automotive vehicle includes an inflator, a holder for the inflator and a folded airbag which is inflatable by means of the inflator in the case of release so that the airbag may deploy. The airbag module may further include at least one magnetic fastening element by means of which the airbag module is adapted to be fastened to a vehicle body of the automotive vehicle.

### CROSS-REFERENCE TO RELATED APPLICATIONS

This application is a national stage of International Application No. PCT/EP2017/077402, filed 26 Oct. 2017, the disclosure of which is incorporated herein by reference in its entirety, and which claimed priority to German Patent Application No. 20 2016 106 156.3, filed 3 Nov. 2016, the disclosure of which is incorporated herein by reference in its entirety.

### TECHNICAL FIELD

The present disclosure generally relates to an airbag module for an automotive vehicle as well as a vehicle body of an automotive vehicle.

### BACKGROUND

Specific airbag modules are mounted on the vehicle body of an automotive vehicle during manufacture of the vehicle. This is the case, for example, for several so called “curtain airbags”, viz. for airbags disposed laterally in the vehicle which are arranged in the area of the upper door frame. Usually, when the airbag modules are mounted, the automotive vehicle is in the “body-in-white” state (BIW state) in which the individual parts of the vehicle body already have been welded to each other. This state may also be referred to as body in white.

For fastening the airbag modules screws or spring clamps, for example clips, are used. Therefore, in the vehicle body at first appropriate bores and/or openings have to be introduced for inserting the screws and/or clamps in the same when fastening the airbag modules so as to mount the airbag module on the vehicle body.

It has turned out to be a drawback in this context that the holes and/or bores first have to be introduced to the vehicle body in an additional manufacturing step, which entails an increased mounting effort and increased accompanying manufacturing cost. Moreover, the flexibility when fastening the airbag modules to the vehicle body is strongly limited as the holes and, resp., bores have already been introduced at predefined positions.

### SUMMARY

The present disclosure relates to an airbag module which is mounted on the vehicle in a simple and cost-efficient manner. According to the present disclosure, the object is achieved by an airbag module for a vehicle comprising an inflator, a holder for the inflator and a folded airbag inflated by the inflator in the case of release so that the airbag will deploy, wherein the airbag module comprises at least one magnetic fastening element by which the airbag module can be fastened to a vehicle body of the automotive vehicle.

It is the basic idea of the present disclosure to fasten the airbag module in a simple and flexible manner by means of a magnetic fastening element to the vehicle body so as to ensure safe support of the airbag module on the vehicle body. In addition, the mounting effort of the airbag module is reduced, while at the same time higher flexibility is given during fastening of the airbag module. Therefore, the manufacturing costs can be reduced, as prior to mounting the airbag module no openings and, resp., bores for fastening the airbag module have to be introduced to the vehicle body. Accordingly, the airbag module is magnetically mounted on the vehicle body

According to one aspect, the at least one magnetic fastening element is a magnetic tape, especially a magnetic adhesive tape. The magnetic fastening element can thus be easily attached to part of the airbag module. If the magnetic tape is a magnetic adhesive tape which is self-adhesive, it can be easily bonded to the appropriate part of the airbag module. After that, the airbag module can be arranged at the desired place of the vehicle body due to the magnetic properties of the magnetic fastening element. The self-adhesive magnetic tape has an adhesive side for the appropriate part of the airbag module and an opposed magnetic side which abuts on the vehicle body.

Another aspect provides that the holder includes a fixation point by which, inter alia, the folded airbag is fixed in position on the holder. The positional fixation ensures, inter alia, that the airbag inflates in the desired way in the case of release. Via the fixation point the position of the folded airbag relative to the holder and thus the inflator arranged thereon is safeguarded, thus ensuring a predefined deployment direction. For example, a fixation element via which the folded airbag, especially one layer of the folded airbag, is coupled to the holder and the inflator is coupled to the holder is provided at the fixation point. The fixation element may be a pin provided on the holder and being especially integrally formed with the holder or may be a separate fixation element such as a screw or the like.

Moreover, the inflator may be coupled to the holder at the fixation point, if desired. Alternatively or in addition, the inflator is clamped or otherwise held within the holder, for example via securing means.

The fixation element may be used as an (additional) mechanical connection of the airbag module, if desired. In particular, the fixation point is provided at a first end portion of the holder. The first end portion may project from the inflator in the axial direction so that the airbag is not fixed in position on the holder in the area of the inflator.

One aspect provides that the airbag is coupled to, especially suspended in, the fixation point via a fixation tab. The fixation tab may be a fabric portion of the airbag having an opening through which the fixation element extends. The fixation tab is thus formed integrally with the airbag. In this way, fixation of the airbag relative to the holder and, resp., to the inflator is safeguarded in a simple manner.

Another aspect provides that the at least one magnetic fastening element is arranged on part of the airbag module so that opposed ends of the at least one fastening element are substantially equally distanced from the fixation point. Accordingly, in a top view the center of the magnetic fastening element is level with the fixation point, especially with respect to the axial extension of the airbag module. The magnetic fastening element may be provided in the area of the fixation point, which results in a fastening point of the airbag module on the vehicle body in the area of the fixation point. Hence the center of the magnetic fastening element is located approximately in the first end portion of the holder.

Furthermore, the at least one magnetic fastening element may be arranged on the folded airbag. If the magnetic fastening element is a magnetic adhesive tape, the latter may be bonded onto the folded airbag, especially onto an outer layer of the folded airbag. The side of the magnetic adhesive tape opposed to the adhesive side accordingly serves for fastening the airbag module to the vehicle body. If the folded airbag is arranged within an envelope, the at least one magnetic fastening element may be fastened to said envelope.

Another aspect provides that the folded airbag is fastened by means of a first peripheral holding element to the holder, especially to the second end portion of the holder. The holding element may be an adhesive tape or a clip collar by which the folded airbag is arranged on the holder. The holding element further serves for securing the folded airbag so that the latter is retained in the folded state and will not automatically deploy, for example by reason of gravitation or by reason of vibrations.

Moreover, the folded airbag may be retained in its folded state by means of a second peripheral holding element. The second peripheral holding element may equally be an adhesive tape or a clip collar. For example, the holding element is arranged in the area of an axial end of the folded airbag, which equally ensures that the folded airbag does not deploy automatically at its axial end.

In accordance with one aspect, the at least one magnetic fastening element is arranged between the first and second holding elements. Due to the two holding elements, it is ensured that the folded airbag has a defined shape in the respective intermediate portion, thus providing a surface which is suited for attaching the magnetic fastening element. This is especially applicable to the adhesive magnetic tape.

According to one embodiment, the at least one magnetic fastening element has a length of from 100 mm to 200 mm, especially 150 mm. The magnetic fastening element may be an elongated magnetic fastening element which is substantially tape-shaped. The width of the magnetic fastening element may range from 1 mm to 10 mm, for example. Said dimensions substantially ensure that the magnetic fastening element has a sufficiently large surface and, accordingly, will exert a sufficiently high magnetic force so as to safely fasten the airbag module to the vehicle body.

Another aspect provides the airbag module to comprise two magnetic fastening elements being associated with the respective opposed end portions of the holder. Since the inflator is disposed at the holder, the largest mass proportion is located within the area of the holder. The two magnetic fastening elements being associated with the end portions of the holder ensure that the entire airbag module is safely mounted on the vehicle body. In addition, a torque is prevented from acting on an end portion of the holder. Rather, the holder and thus the airbag module are supported in a substantially symmetric manner.

According to one embodiment, the airbag module is a side airbag module. Such side airbag module may be a “curtain airbag module”, i.e. a side airbag module arranged in the area of the door frame. Said airbag modules excel by their elongate shape, with the holder and the inflator arranged thereon comprising merely part of the axial length of the airbag module, as the axial length is mainly defined by the folded airbag. Nevertheless, the magnetic fastening elements ensure safe fastening of the elongated airbag module.

Furthermore, according to the present disclosure the object is achieved by a vehicle body comprising an airbag module of the afore-mentioned type. The afore-mentioned advantages are resulting analogously for the vehicle body, especially as regards the mounting effort.

Moreover, the airbag module may be fastened free from screws and/or clamps to the vehicle body at least outside a fixation point. The airbag module thus may be fastened to the vehicle body in a relatively flexible manner.

According to a further aspect, the vehicle body is formed, apart from a maximum of one or two fastening points, at least in a positioning area of an airbag module free from interfaces, especially without any bore and/or opening for receiving screws and, resp., clamps which serve for fastening the airbag module. The manufacture of the vehicle body is facilitated as in the vehicle body no interfaces for screws and/or clamps are provided that would be required to be introduced prior to fastening the airbag module, which would entail an additional working step. The airbag module may be fastened to the vehicle body in a flexible and simple manner, as by means of the magnetic fastening elements high flexibility during assembly is ensured.

Further advantages and characteristics of the present disclosure will be resulting from the following description and the drawing which will be referred to.

### BRIEF DESCRIPTION OF THE DRAWINGS

These and other features and advantages of the present disclosure will be apparent from the following detailed description, best mode, claims, and accompanying drawings in which:

FIG. 1 illustrates an airbag module according to the present disclosure.

Like Reference Numerals Refer to Like Parts Throughout the Description of Several Views of the Drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any manner.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

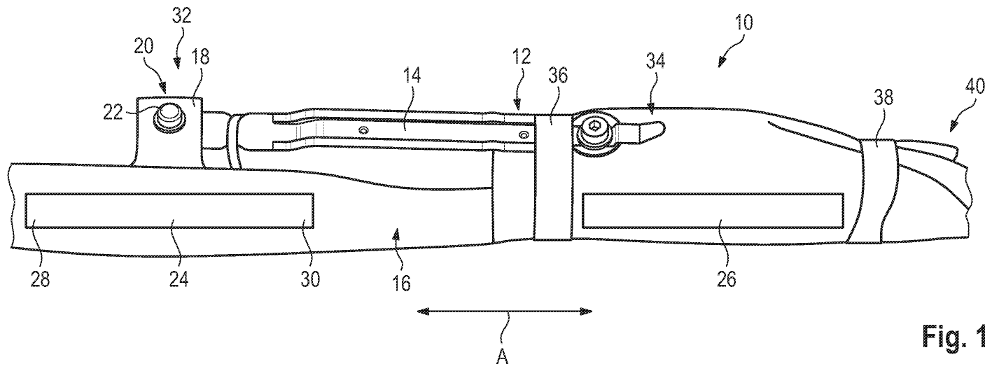

With reference to FIG. 1, an airbag module 10 according to the present disclosure is shown which is a side airbag module, more exactly a so called “curtain airbag module”.

The airbag module 10 comprises an inflator 12 not shown here which is retained by a holder 14. In addition, the airbag module 10 comprises an airbag 16 provided in the folded state in the shown embodiment in which the inflator 12 is accommodated at least partly which is why the inflator 12 is not visible.

The folded airbag 16 includes an external fabric portion or, resp., an outer layer comprising a fixation tab 18 by which the airbag 16 is fixed in position on the holder 14. For this purpose, the holder 14 comprises a fixation point 20 through which a fixation element 22 in the form of a screw extends in the shown embodiment.

Alternatively to the separately formed fixation element 22, a pin, bolt or similar fixation element extending through the fixation tab 18 and, resp., being suspended in the fixation tab 18 may be formed integrally with the holder 14.

The inflator 12 can be further fixed on the holder 14 via the fixation element 22. Alternatively or additionally, the inflator 12 is held to be clamped on the holder 14 and/or via additional securing means.

For fastening the airbag module 10 to a vehicle body of the automotive vehicle, especially a body in white, the airbag module 10 in the shown embodiment includes two magnetic fastening elements 24, 26 in the form of magnetic tapes which are self-adhesive. The magnetic fastening elements 24, 26 thus are magnetic adhesive tapes.

Hence each of the two magnetic fastening elements 24, 26 includes an adhesive side and an opposed magnetic side. The magnetic fastening elements 24, 26 are arranged by means of their adhesive sides to the outer layer of the folded airbag 16, as is evident from the FIGURE.

The first magnetic fastening element 24 is arranged on the folded airbag 16 so that each of its ends 28, 30 has a substantially equal distance from the fixation point 20 provided at a first end portion 32 of the holder 14.

In other words, the first magnetic fastening element 24 is arranged on the folded airbag 16 so that its center has the shortest distance from the fixation point 20 as compared to the other parts of the first magnetic fastening element 24.

Since the fixation point 20 is located in the first end portion 32 of the holder 14, this means that the center of the first magnetic fastening element 24 is located substantially on a connecting line with the first end of the holder 14 which connecting line is perpendicular to the axial extension A of the airbag 16 and, resp., of the airbag module 10.

The second magnetic fastening element 26, on the other hand, is associated with a second end portion 34 of the holder 14 which is opposed to the first end portion 32.

The fastening elements 24, 26 are fastened by means of their adhesive sides on the respective outer layer of the folded airbag 16 so that the airbag module 10 may be fastened to the vehicle body by means of the opposed magnetic sides of the fastening elements 24, 26.

Accordingly, the entire airbag module 10 is fastened to the vehicle body via the two magnetic fastening elements 24, 26, wherein the magnetic fastening elements 24, 26 are associated with the end portions 32, 34 of the holder 14. This guarantees homogenous force distribution and, resp., force transmission to the vehicle body so that safe mounting of the airbag module 10 is ensured. Especially, torques are prevented at the end portions 32, 34 of the holder 14 in this way. The airbag module 10 is thus fastened to the vehicle body exclusively via the magnetic fastening elements 24, 26.

It is further resulting from the FIGURE that the folded airbag 16 is fastened on the holder 14 via a first peripheral holding element 36 which is in the form of a holding tape, especially an adhesive tape, in the shown embodiment. In addition, a second peripheral holding element 38 is provided in the area of an axial end 40 of the folded airbag 16 which is associated with the second end portion 34 of the holder 14.

Both holding elements 36, 38 serve for holding the folded airbag 16 in its folded state so that the latter will not inadvertently deploy, especially on the end side. The holding elements 36, 38 surround the periphery of the airbag 16 substantially folded to a roll.

The second magnetic fastening element 26 extends substantially perpendicularly to the holding elements 36, 38 and is arranged between the two holding elements 36, 38.

Accordingly, the second magnetic fastening element 26 extends in the axial direction A relative to the folded airbag 16, whereas the two holding elements 36, 38 are laid around the folded airbag 16 in the circumferential direction.

The first magnetic fastening element 24 extends substantially in parallel to the second magnetic fastening element 26, viz. equally in the axial direction A of the folded airbag 16 and, resp., of the airbag module 10.

The two magnetic fastening elements 24, 26 are self-adhesive magnetic tapes, as explained already. They have a length of from 100 m to 200 mm, especially a length of 150 mm. The width of the magnetic fastening elements 24, 26 may be from 1 mm to 10 mm.

Due to these dimensions of the magnetic fastening elements 24, 26, a sufficiently large magnetically active surface is provided for ensuring safe fastening of the airbag module 10 on the vehicle body by means of the two magnetic fastening elements 24, 26.

Since the airbag module 1 is fastened on the vehicle body by means of the magnetic fastening elements 24, 26, at least outside the fixation point 20 the airbag module 10 may be fastened on the vehicle body free from screws and, resp., clamps, especially exclusively via the magnetic fastening elements 24, 26.

Accordingly, no interface has to be provided on the vehicle body, viz. no opening and/or bore which serves for receiving clamps and/or screws. The vehicle body is thus configured to be free from interfaces.

Hence the airbag module 10 is fastened quickly and easily, as the additional working step in which the openings and/or bores have first been introduced to the vehicle body may be saved.

The magnetic fastening elements 24, 26 further need not include any protective films or the like which first have to be removed so as to attach the magnetic fastening elements 24, 26 to a part of the airbag module 10, which allows to save a respective working step. In addition, this helps to preserve the environment.

Preferably the magnetic fastening elements 24, 26 are in the form of rolls which have been unrolled and cut so that they have been attached to part of the airbag module 10 when cut to length.

Instead of the outer layer of the folded airbag 16, the fastening elements 24, 26 may also be arranged on the holder 14, on part of the inflator 12 and/or on an envelope of the folded airbag 16 in which the airbag 16 is received in the folded state.

Alternatively to the exclusive fastening of the airbag module 10 by means of the magnetic fastening elements 24, 26, the fixation element 22 serving for fixing the airbag 16 to the holder 12 may further be used, if desired, for additionally fixing the airbag module 10 mechanically to a vehicle body. The airbag module 10 in that case would be fastened mechanically and magnetically. For this purpose, an appropriate interface would have to be provided in the vehicle body in the area of the fixation point 20 of the airbag module 10, however.

In general, the present disclosure provides a cost-efficient and flexible option which is easy to manufacture for fastening the airbag module 10 to the vehicle body.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. An airbag module for an automotive vehicle comprising an inflator, a holder for the inflator and a folded airbag which is inflatable by means of the inflator in the case of release so that the airbag may deploy, wherein the airbag module comprises at least one magnetic fastening element by means of which the airbag module is adapted to be fastened to a vehicle body of the automotive vehicle.

2. The airbag module according to claim 1 wherein the at least one magnetic fastening element is a magnetic tape, especially a magnetic adhesive tape.

3. The airbag module according to claim 1 wherein the holder includes a fixation point by which inter alia the folded airbag is fixed in position on the holder.

4. The airbag module according to claim 3 wherein the fixation point is provided on a first end portion of the holder.

5. The airbag module according to claim 3 wherein the airbag is coupled to, especially suspended in, the fixation point by means of a fixation tab.

6. The airbag module according to claim 1 wherein the at least one magnetic fastening element is arranged on part of the airbag module so that opposed ends of the at least one fastening element are substantially equally distanced from the fixation point.

7. The airbag module according to claim 1 wherein the at least one magnetic fastening element is arranged on the folded airbag.

8. The airbag module according to claim 1 wherein the folded airbag is fastened to the holder, especially to the second end portion of the holder, by means of a first peripheral holding element.

9. The airbag module according to claim 1 wherein the folded airbag is retained in its folded state by means of a second peripheral holding element.

10. The airbag module according to claim 8 wherein the at least one magnetic fastening element is arranged between the first and second holding elements.

11. The airbag module according to claim 1 wherein the at least one magnetic fastening element has a length of from 100 mm to 200 mm, especially 150 mm.

12. The airbag module according to claim 1 wherein the airbag module comprises two magnetic fastening elements which are associated with the respective opposed end portions of the holder.

13. The airbag module according to claim 1 wherein the airbag module is a side airbag module, preferably a head airbag.

14. A vehicle comprising:
a vehicle body; and
an airbag module further including an inflator, a holder for the inflator; and a folded airbag which is inflatable by means of the inflator in the case of release so that the airbag may deploy;
wherein the airbag module comprises at least one magnetic fastening element by means of which the airbag module is adapted to be fastened to a vehicle body of the automotive vehicle.

15. The vehicle body according to claim 14 wherein at least outside a fixation point the airbag module is fastened on the vehicle body free from screws and/or clamps.

16. The vehicle body according to claim 14 wherein the vehicle body is configured at least in a positioning portion of an airbag module free from interfaces.
